(19) United States
(12) Patent Application Publication
(10) Pub. No.: US 2018/0207972 A1
(43) Pub. Date: Jul. 26, 2018

(54) IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventor: Mitsuhisa KATO, Yokohama Kanagawa (JP)

(21) Appl. No.: 15/810,786

(22) Filed: Nov. 13, 2017

Related U.S. Application Data
(63) Continuation of application No. 15/412,823, filed on Jan. 23, 2017, now Pat. No. 9,821,591.

(51) Int. Cl. B41M 7/00

(52) U.S. Cl. CPC B41M 7/0009

(57) ABSTRACT

An image forming apparatus according to an embodiment includes a decolorable image forming unit that forms a decolorable image with a decolorable material. A mask control unit controls the decolorable image forming unit to form, with the decolorable material on a sheet, a mask that hides at least one portion of an image formed on the sheet with non-decolorable material.

### CROSS-REFERENCE TO RELATED APPLICATIONS

This application is a continuation of U.S. patent application Ser. No. 15/412,823, filed on Jan. 23, 2017, the entire contents of each of which are incorporated herein by reference.

### FIELD

Embodiments described herein relate generally to an image forming apparatus and a mask forming method.

### BACKGROUND

In recent years, the importance of information security such as preventing leakage of personal information is increased. For example, personal information on a document may be leaked by a method such as “shoulder surfing” (peeking over a user's shoulder).

However, the document having the personal information typically has no means to hide information that a person may be desired to be kept secret. Thus, it is difficult to prevent personal information leakage.

### DESCRIPTION OF THE DRAWINGS

FIG. 1 is a perspective view illustrating an example configuration of an image forming apparatus according to an embodiment;

FIG. 2 is an example cross-sectional view of the image forming apparatus;

FIG. 3 is a block diagram illustrating an example configuration of a control system of a printer unit;

FIG. 4 is a view illustrating an example of attaching a mask to an employee card (A), and an example of erasing the mask from the employee card (B);

FIG. 5 is a view illustrating an example of attaching a mask to a customer card (A), and an example of erasing the mask from the customer card (A);

FIG. 6 is a flowchart of an example sequence of operations for forming an image and a mask on a new sheet;

FIG. 7 is a flowchart of an example sequence of operations for forming a mask in a case in which a format is fixed;

FIG. 8 is a flowchart of an example sequence of operations for storing mask information;

FIG. 9 is a flowchart of an example sequence of operations for forming a mask;

FIG. 10 is a flowchart of an example sequence of operations for forming coded mask information; and

FIG. 11 is a flowchart of another example sequence of operations for forming a mask.

### DETAILED DESCRIPTION

An image forming apparatus according to an embodiment includes a decolorable image forming unit that forms a decolorable image with a decolorable material. A mask control unit controls the decolorable image forming unit to form, with the decolorable material on a sheet, a mask that hides at least one portion of an image formed on the sheet with non-decolorable material.

Hereinafter, an image forming apparatus and a mask forming method of an embodiment are described with reference to the accompanying drawings. Further, “decoloring” according to the present embodiment refers to a processing of making a visible image formed with a color (containing not only chromatic colors but also achromatic colors such as white, black and the like) to be invisible.

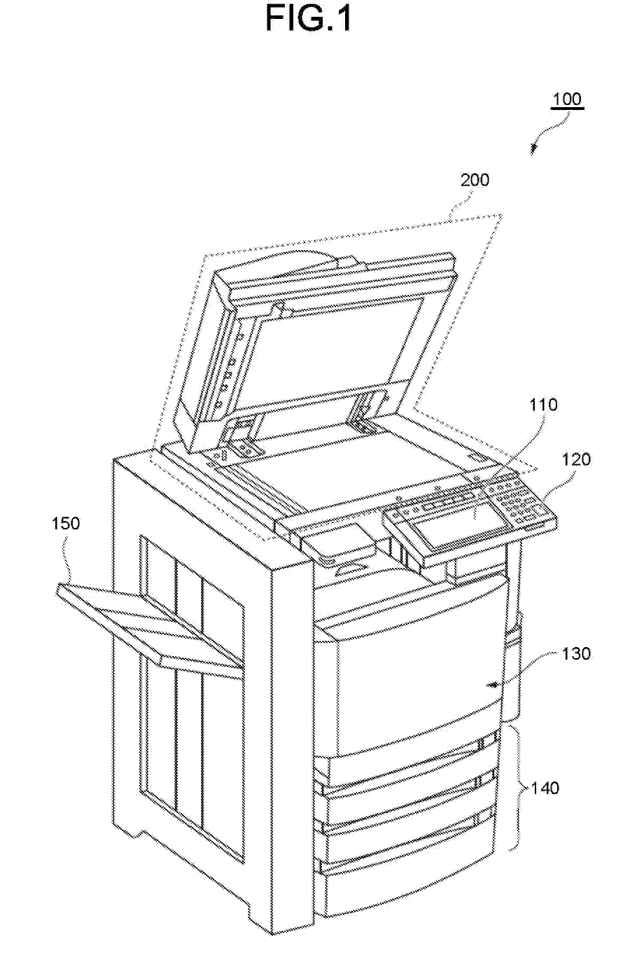

FIG. 1 is a perspective view illustrating an example configuration of an image forming apparatus 100 according to the embodiment. The image forming apparatus 100 is, for example a multi-functional peripheral. The image forming apparatus 100 includes a display 110, a control panel 120, a printer unit 130, a sheet housing unit 140 and an image reading unit 200. The printer unit 130 of the image forming apparatus 100 may be a device for fixing a toner image or an inkjet type device. The cartridge of toner and the cartridge of ink are collectively referred to simply as a cartridge. The toner includes both decolorable toner that can be decolored later and toner (hereinafter, referred to as “non-decolorable toner”) that cannot be decolored.

The image forming apparatus 100 forms an image on a sheet with a recording agent such as toner. The sheet is, for example, a paper or a label paper. The sheet may be any object as long as the image forming apparatus 100 can form an image on the its surface.

The display 110 is an image display device such as a liquid crystal display, an organic EL (Electro Luminescence) display or the like. The display 110 displays various kinds of information relating to the image forming apparatus 100.

The control panel 120 includes a plurality of buttons. The control panel 120 receives an operation input by a user. The control panel 120 outputs a signal corresponding to the operation input by the user to a control unit of the image forming apparatus 100. The display 110 and the control panel 120 can be separate or both may be integrated into a single touch panel.

The printer unit 130 forms an image on a sheet on the basis of image information generated by the image reading unit 200 or image information received via a communication interface. The printer unit 130 forms an image through, for example, the following process. The image forming unit of the printer unit 130 forms an electrostatic latent image on a photoconductive drum based on the image information. The image forming unit of the printer unit 130 applies the recording agent to the electrostatic latent image to form a visible image. As an example of the recording agent, toner may be used. The transfer unit of the printer unit 130 transfers the visible image onto the sheet. The fixing unit of the printer unit 130 applies heat and pressure to the sheet to fix the visible image on the sheet.

Further, the sheet on which the image is formed may be a sheet supplied from the sheet housing unit 140 or a manually fed sheet. The sheet housing unit 140 houses the sheet used for the image formation by the printer unit 130. After the image formation is carried out, the sheet is discharged to a tray 150.

The image reading unit 200 generates the image information by reading a read object as intensity of light. The image reading unit 200 records the generated image information. The generated image information may be sent another information processing apparatus via a network. The generated image information may be used for the image formation on the sheet through the printer unit 130.

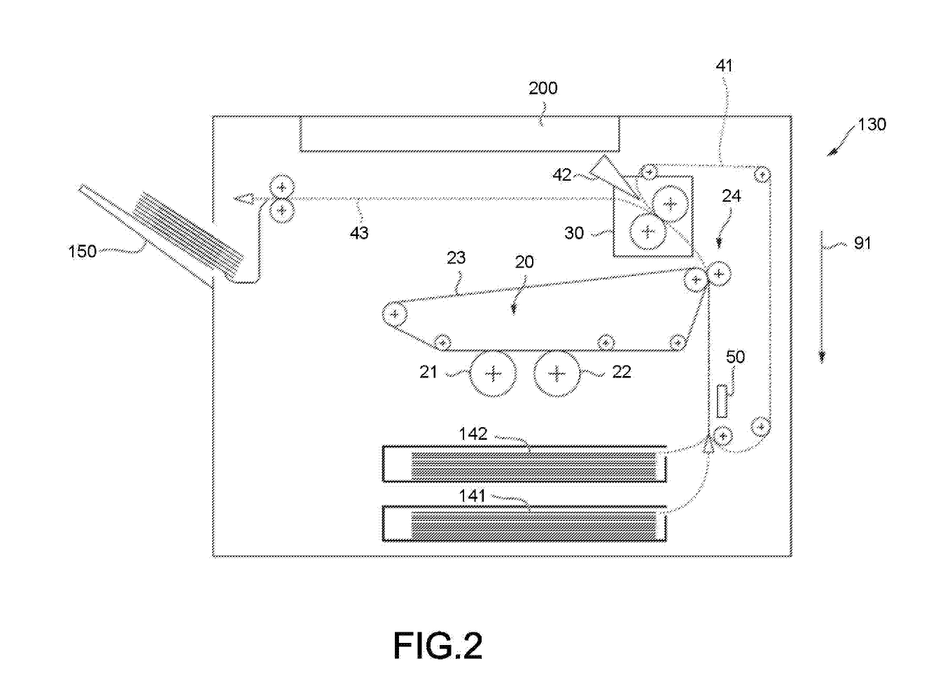

FIG. 2 is a cross-sectional view illustrating the image forming apparatus 100 shown in FIG. 1. FIG. 2 illustrates the configuration of main portion of the printer unit 130. An image forming unit 20 is includes a first image forming unit 21, a second image forming unit 22, a transfer belt 23 and a secondary transfer unit 24. In the first image forming unit 21 (non-decolorable image forming unit), the non-decolorable toner (which is fixed on the sheet at the temperature of 110 degrees centigrade) is used. In the second image forming unit 22 (decolorable image forming unit), the decolorable toner (which is fixed on the sheet at the temperature of 110 degrees centigrade and decolored at the temperature of 130 degrees centigrade) is used. The toner image formed in the first image forming unit 21 is temporarily transferred onto the transfer belt 23. Then, the toner image is transferred onto a sheet 141 or a sheet 142 which is supplied from the sheet housing unit 140 in the secondary transfer unit 24. The sheet to which the toner image is transferred is fixed in a fixing device 30 at 110 degrees centigrade.

A conveyance control device 42 controls a sheet conveyance, and the sheet passes through a conveyance path 41 towards the direction of a direction 91 and returns to the secondary transfer unit 24 again. During this time, the toner image formed in the second image forming unit 22 is transferred onto the transfer belt 23. Then, the toner image is superposed and transferred onto the sheet which passes through the conveyance path 41 and returns in the secondary transfer unit 24. The sheet to which the toner transfer is carried out is fixed in a fixing device 30 at 110 degrees centigrade. Then, the conveyance control device 42 controls the sheet conveyance, and the fixed sheet passes through the conveyance path 41. Then, the sheet on which the non-decolorable toner and the decolorable toner are fixed is discharged to the tray 150.

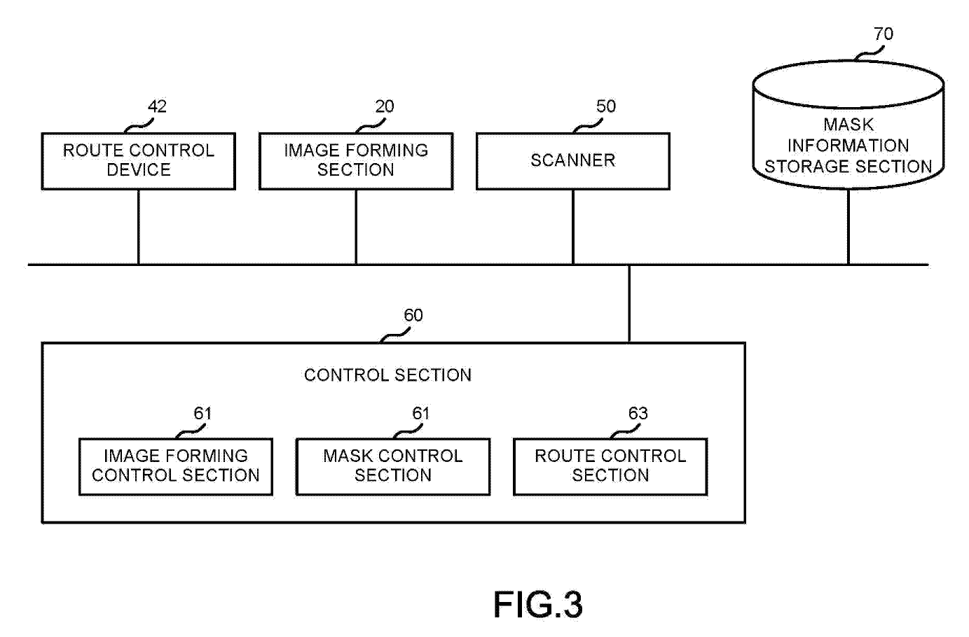

FIG. 3 is a block diagram illustrating an example configuration of a control system of the printer unit 130 shown in FIG. 2. A control unit 60 collectively controls the operations of the image forming unit 20, the conveyance control device 42, and the scanner 50. The scanner 50 reads the image formed on the sheet before the toner transfer in the secondary transfer unit 24. The control unit 60 is provided with an image forming control unit 61, a mask control unit 62 and a conveyance control unit 63. The image forming control unit 61 controls the operations of the image forming unit 20. The mask control unit 62 controls the operations for forming a mask on the sheet. The conveyance control unit 63 controls the operations for the conveyance control device 42. A mask information storage unit 70 stores mask information for a mask formed on the sheet.

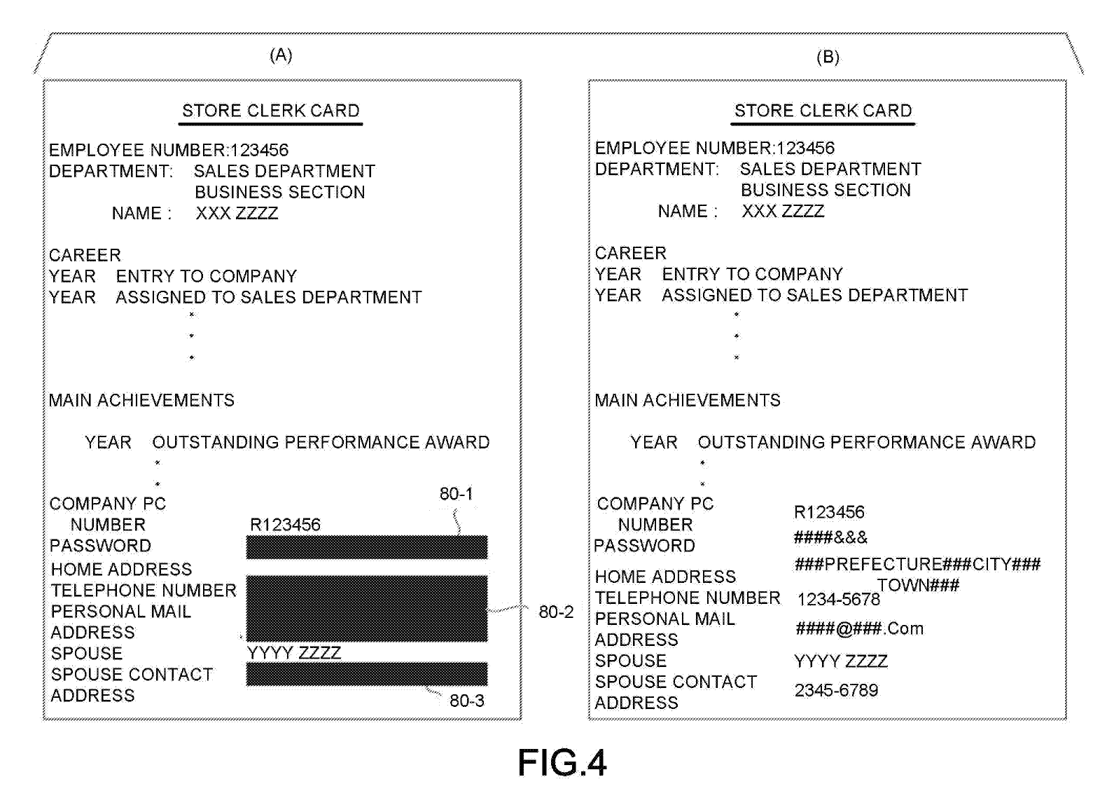

Herein, the mask formed on the sheet is described. FIG. 4 is a view illustrating an example (A) of a mask included on an employee card used in an enterprise and an example (B) of erasing the mask from the employee card. Information that is not desired to be known to others is included in the employee card. In this example, for example, the information includes a password, a home address, a telephone number, a personal e-mail address and a spouse contact address. In the example shown in FIG. 4(A), masks 80-1, 80-2 and 80-3 are formed on the sheet in order to hide the information. Character information of the employee card is formed on the sheet with the non-decolorable toner. Thus, the character information cannot be erased. On the other hand, the masks 80-1, 80-2 and 80-3 are formed with the decolorable toner. Thus, in a case in which the information hided by the mask is requested, it is possible to refer to the hided information by decoloring the decolorable toner (FIG. 4(B)). Then, it is possible to hide the information again by forming the mask on the sheet again.

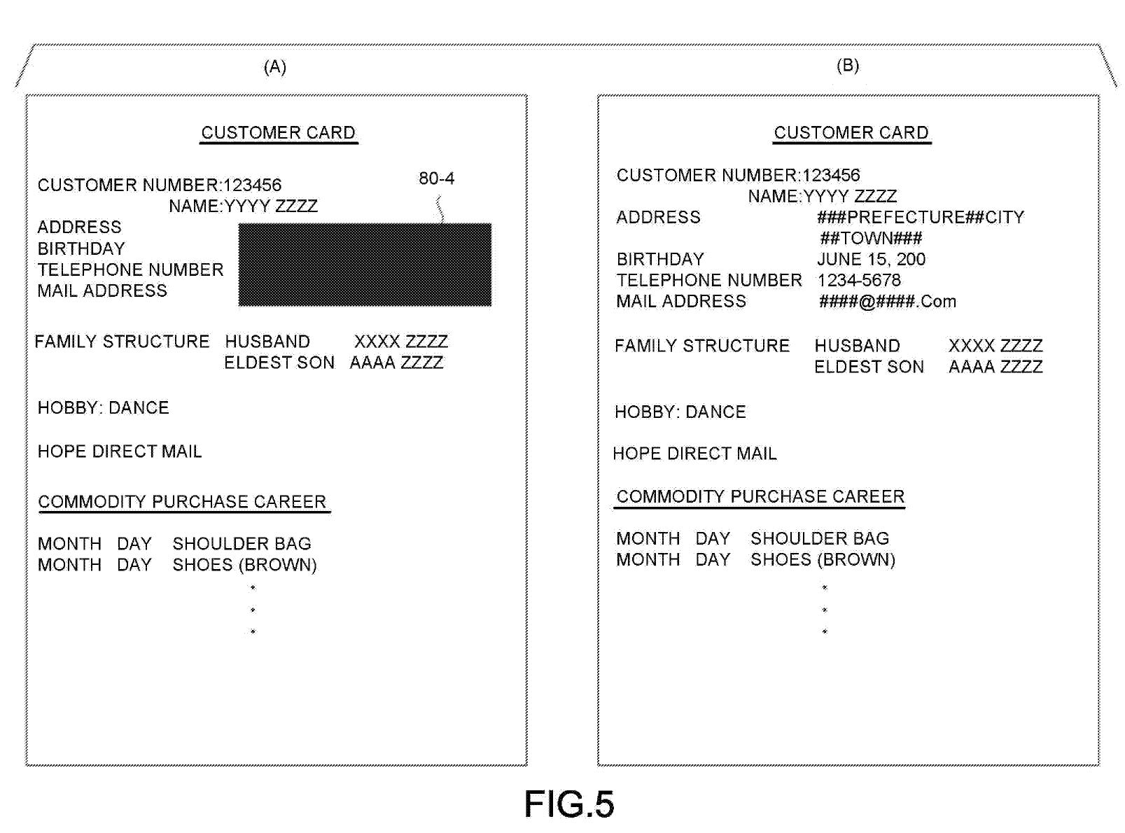

FIG. 5 is a view illustrating an example (A) a mask included on a customer card used in a store and an example (B) of erasing the mask from the customer card. The customer card also includes information that is not desired to be known to others like the employee card. In this example, the information includes an address, date of birth, a telephone number, and an e-mail address. In the example shown in FIG. 5 (A), a mask 80-4 is formed on the sheet in order to hide the information. Thus, in a case of referring to the information hided by the mask, it is possible to refer to the hidden information by decoloring the mask formed with the decolorable toner.

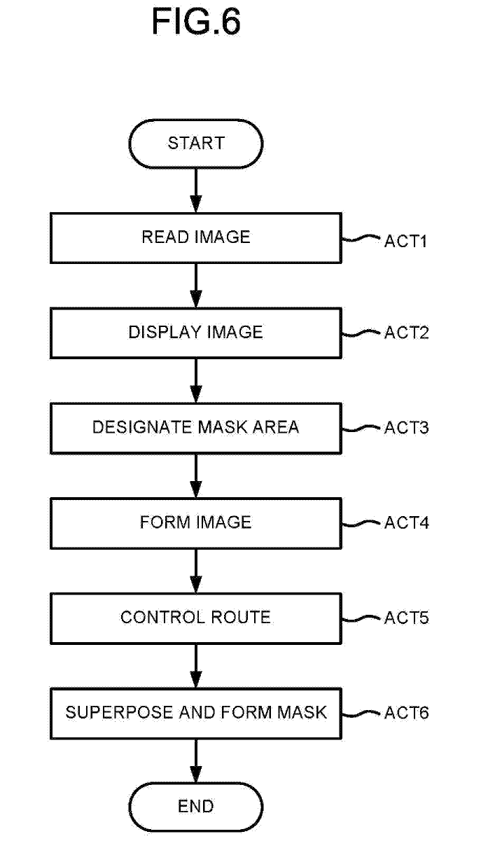

Next, with reference to FIG. 6, the operations of the control system shown in FIG. 3 are described. First, the operations for forming an image and a mask on a new sheet are described. FIG. 6 is a flowchart illustrating the operations for forming an image and a mask on a new sheet. Herein, an example of a case in which the image formed on the sheet is the employee card is described. A user operates the control panel 120 to select a security mode. If the security mode is selected, the mask control unit 62 gives an instruction to place a sheet with an original image in the image reading unit 200 on the display 110. The user, for example, places the sheet with the original image shown in FIG. 4 (B) on the image reading unit 200, and carries out an operation for starting execution on the control panel 120.

The image reading unit 200 reads the original image, and temporarily stores the information of the read original image therein (ACT 1). The control unit 60 displays the image on the display 110 (ACT 2). The control unit 60 controls the display 110 to display an instruction to carry out the operation of designation of a mask area. The user observes the image displayed on the display 110, and operates the control panel 120 to carry out the designation of the mask area (ACT 3). For example, the masks 80-1, 80-2 and 80-3 shown in FIG. 4(A) are designated. The mask control unit 62 specifies a coordinate value of the designated mask area based on the operation of the user.

Next, the image forming unit 20 forms the image generated in the image reading unit 200 on the sheet supplied from the sheet housing unit 140 with the non-decolorable toner (ACT 4). Then, the conveyance control unit 63 controls the conveyance control device 42 so that the sheet after the image formation is carried out is conveyed on the conveyance path 41 shown in FIG. 2 afterpassing through a fixing unit 30 (ACT 5). Subsequently, the image forming unit 20 superposes and forms the mask on the sheet after the image formation is carried out on the basis of the coordinate value of the mask area with the decolorable toner (ACT 6). Then, the conveyance control unit 63 controls the conveyance control device 42 so that the sheet having the mask form thereon is conveyed on the conveyance path 43 shown in FIG. 2, and discharges the sheet having the mask formed thereon is carried out to the tray 150. Through the operations, the employee card shown in FIG. 4(A) is discharged to the tray 150.

Next, the operations for decoloring the mask formed on are described. First, the user puts the sheet on which the mask is formed into the sheet housing unit 140. At this time, the sheet may be placed manually. The user operates the control panel 120 to select a mask erasing mode. When the mask erasing mode is selected, the mask control unit 62 conveys the sheet on which the mask is formed from the sheet housing unit 140 to the fixing unit 30. Then, the mask part on the sheet is erased by the fixing unit which is heated to 130 degrees centigrade. The sheet on which the mask is erased is conveyed on the conveyance path 43 shown in FIG. 2 and discharged to the tray 150. Through the operations, the employee card shown in FIG. 4 (B) is discharged to the tray 150.

The designation of the mask area may be carried out in such a manner that the user carries out marking in advance in addition to being carried out on the display. In other words, an area to be masked may be painted out with a high-lighter on the sheet placed in the image reading unit 200, and the painted-out area is read by the image reading unit 200. Then, the painted-out area is set as the mask area. In this manner, the designation of the mask area can be easily carried out.

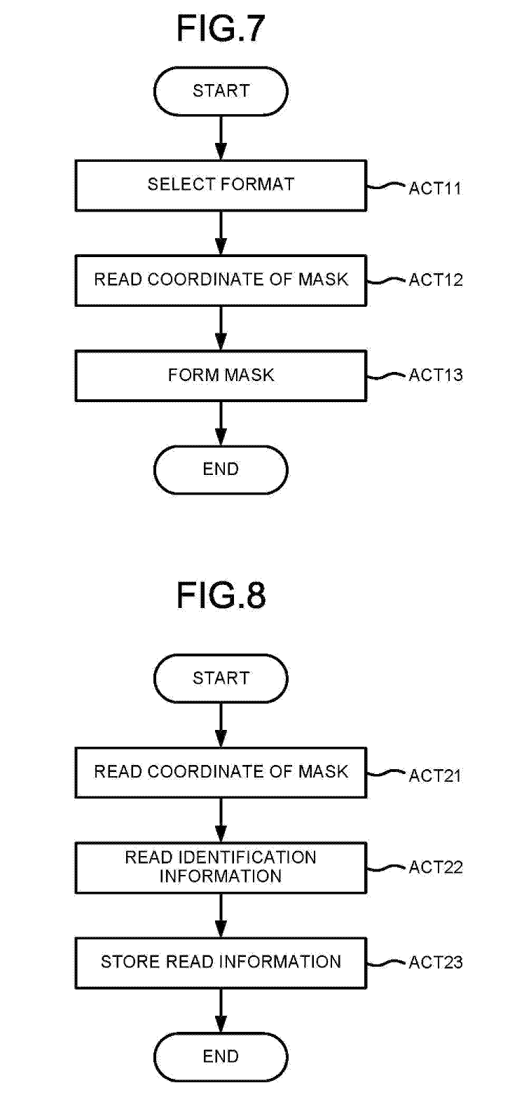

Next, operations for forming a mask on a sheet on which a mask is formed in a case in which a format is fixed like the employee card shown in FIG. 4 are described. FIG. 7 is a flowchart illustrating the mask forming operation in a case in which the format is fixed. Herein, a case in which the format of the sheet on which the mask is formed is the employee card is described. First, the user operates the control panel 120 to select the security mode for a case in which the format is fixed. The user selects a format of the sheet on which the mask is formed from the formats displayed on the display 110 (ACT 11). Herein, the “employee card” is selected. The user puts the sheet on which the image of the employee card is formed into the sheet housing unit 140. At this time, the sheet may be placed manually. Then, the user carries out the operation for starting the execution on the control panel 120.

Next, the mask control unit 62 reads coordinate information of the mask for the selected format from the mask information storage unit 70 (ACT 12). The coordinate information of the information which is supposed to be masked is stored in the mask information storage unit 70 for each format in advance. For example, in the case of the employee card shown in FIG. 4, the coordinate information of the masks 80-1, 80-2 and 80-3 are stored in advance. In the case of the customer card shown in FIG. 5, the coordinate information of the mask 80-4 is stored in advance.

Next, the image forming unit 20 superposes and forms the mask on the sheet of the employee card with the decolorable toner on the basis of the coordinate information of the mask area (ACT 13).

In this manner, the coordinate information of the mask corresponding to the format is stored in advance, and the designation of the mask area is possible by simply selecting the format, and thus it is possible to omit the job of the designation of the mask area.

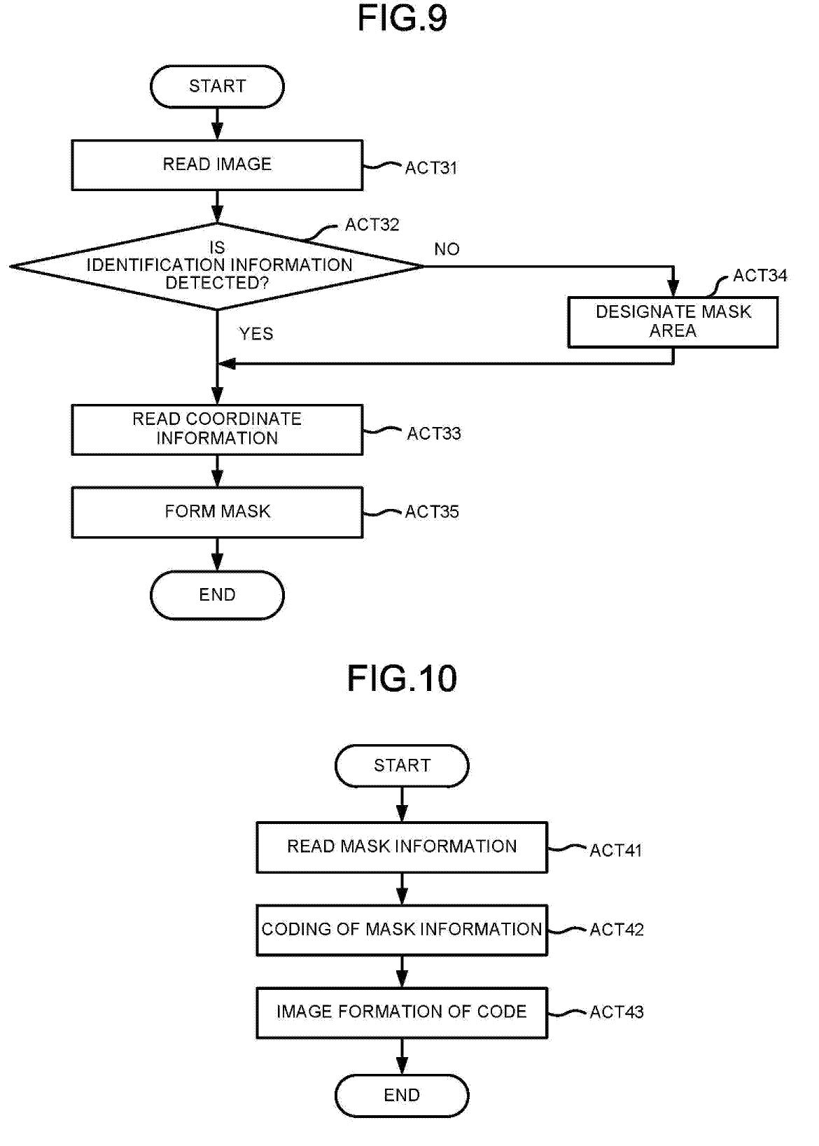

Next, at the time of the decoloring of the mask, the operations for storing the mask information before the decoloring of the mask is carried out in advance and forming the mask again on the basis of the stored mask information are described. FIG. 8 and FIG. 9 are flowcharts illustrating the operations for forming the mask again on the basis of the stored mask information. First, with reference to FIG. 8, the operations for storing the mask information in advance are described. Through the foregoing operations, at the time of the decoloring of the mask, the coordinate information of the mask to be decolored is read by the scanner 50 before the sheet arrives at the secondary transfer unit 24 from the sheet housing unit 140 (ACT 21). Further, the scanner 50 reads identification information for identifying the conveyed sheet (ACT 22). The identification information described herein refers to an employee number in the case of the employee card shown in FIG. 4. The identification information refers to a customer number in the case of the customer card shown in FIG. 5. In other words, information which can uniquely identify the sheet on which the mask is decolored is generally the identification information.

Next, the mask control unit 62 stores the coordinate information of the mask read by the scanner 50 and the identification information of the sheet in the mask information storage unit 70 in an associated manner (ACT 23).

Through the operations, the setting of the same mask can be easily carried out again by storing the coordinate information of the mask and the identification information of the sheet in advance in an associated manner before decoloring the mask.

Next, with reference to FIG. 9, the operations for forming the mask again by using the identification information of the sheet are described. First, the user inputs the sheet into the sheet housing unit 140 at the time of forming the mask again. Then, the user selects the security mode. The scanner 50 reads the image of the sheet before the sheet arrives at the secondary transfer unit 24 from the sheet housing unit 140 (ACT 31). Then, the mask control unit 62 determines whether or not the identification information for identifying the sheet is detected in the image read by the scanner 50 (ACT 32). If the identification information is detected (YES in ACT 32), the mask control unit 62 reads the coordinate information of the mask associated with the identification information from the mask information storage unit 70 (ACT 33). Then, the mask control unit 62 forms the mask on the sheet by using the coordinate information of the mask (ACT 35).

On the other hand, if the identification information is not detected (No in ACT 32), the mask control unit 62 displays the image read by the scanner 50 on the display 110. Then, the mask control unit 62 carries out the designation of the mask area similarly with the foregoing operation and carries out the formation of the mask on the basis of the designated mask area (ACT 35).

In this manner, in a case in which the identification information is detected, as the stored mask information is used, the designation of the mask information can be easily carried out.

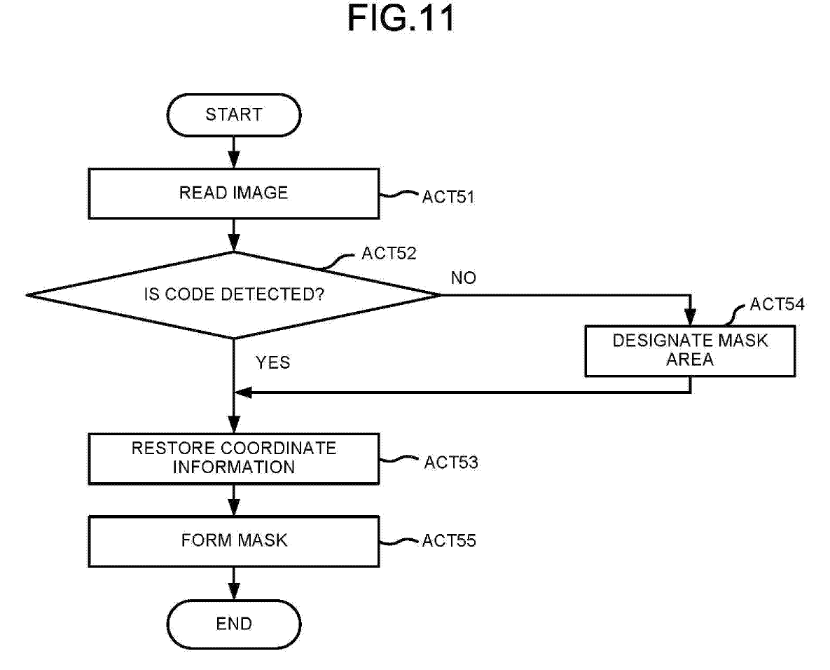

Next, at the time of the decoloring of the mask, the operations for coding the mask information before the decoloring of the mask is carried out and carrying out forming the mask again on the basis of the coded mask information are described. FIG. 10 and FIG. 11 are flowcharts illustrating the operations for forming the mask using coded mask information. First, with reference to FIG. 10, the operations for coding the mask information and forming the image on the sheet are described. Through the foregoing operation, at the time of the decoloring of the mask, the coordinate information of the mask to be decolored is read by the scanner 50 before the sheet arrives at the secondary transfer unit 24 from the sheet housing unit 140 (ACT 41).

Next, the mask control unit 62 codes the coordinate information of the mask read by the scanner 50 with a two-dimensional code (data matrix code) (ACT 42). Then, the image forming control unit 61 controls the image forming unit 20 to carry out the image formation on the two-dimensional code at any one corner of four corners of the sheet using the non-decolorable toner (ACT 43). After the two-dimensional code is fixed by the fixing unit 30, the sheet is conveyed on the conveyance path 41 by the conveyance control device 42, and the decoloring of the mask is carried out at a point of time at which the sheet arrives at the fixing unit 30 again.

Through the operations, the setting of the same mask can be easily carried out again by coding the coordinate information of the mask and carrying out the image formation including the code before decoloring the mask.

Next, with reference to FIG. 11, operations for carrying out the setting of the mask again by using the two-dimensional code on the sheet are described. First, the user puts the sheet into the sheet housing unit 140 at the time of carrying out the setting of the mask again. Then, the user selects the security mode. The scanner 50 reads the image of the sheet before the sheet arrives at the secondary transfer unit 24 from the sheet housing unit 140 (ACT 51). The mask control unit 62 determines whether or not the two-dimensional code is detected in the image read by the scanner 50 (ACT 52). If the two-dimensional code is detected (YES in ACT 52), the mask control unit 62 determines the coordinate information of the mask from the two-dimensional code (ACT 53). Then, the mask control unit 62 forms the mask on the sheet by using the determined coordinate information of the mask (ACT 55).

On the other hand, if the two-dimensional code is not detected (No in ACT 52), the mask control unit 62 displays the image read by the scanner 50 on the display 110. Then, the mask control unit 62 carries out the designation of the mask area similarly with the foregoing operation and carries out the formation of the mask on the basis of the designation (ACT 55).

In this manner, if the two-dimensional code is detected, as the coordinate information of the mask is determined from the two-dimensional code, the designation of the mask information can be easily carried out.

The two-dimensional code formed on the sheet may be a one-dimensional code (barcode). Further, other coding methods may be used. In other words, the coding method is not limited as long as the coordinate information of the mask can be determined from the code through the image reading.

As stated above, on the sheet having personal information that is desired to be kept secret, the mask can be formed with the decolorable toner to hide the personal information. In a case of wanting to confirm or review the information which is hid by the mask, as the mask is formed with the decolorable toner, only the mask can be decolored. Furthermore, on the decolored sheet, in a case of forming the mask again, as the mask is formed on the basis of the information of the non-decolored mask, formation of the mask can be easily carried out.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1.-20. (canceled)

21. An image forming apparatus, comprising:
a transfer belt;
a non-decolorable image forming unit configured to form a temporary image on the transfer belt using non-decolorable toner;
a decolorable image forming unit configured to form a temporary image on the transfer belt using decolorable toner;
a transfer unit configured to transfer each temporary image formed on the transfer belt to a sheet;
a fixing device configured to fix the temporary image formed of any one of the decolorable toner and non-decolorable toner to the sheet by heating the sheet to a fixing temperature;
a conveyance control device configured to control conveyance of the sheet;
a control panel configured to receive a selection of one of a security mode and an erasing mode; and
a control unit configured to, when the erasing mode is selected, control the conveyance control device to convey a sheet, on which a decolorable image formed with the decolorable toner is fixed, to the fixing device and control the fixing device to decolor the decolorable image by heating the sheet to a decoloring temperature higher than the fixing temperature.

22. The apparatus according to claim 21, further comprising a conveyance path that conveys the sheet from a position downstream of the fixing device in a sheet conveying direct to a position upstream of the transfer unit in the sheet conveying direction.

23. The apparatus according to claim 21, wherein, when the security mode is selected, the control unit:
controls the non-decolorable image forming unit, transfer unit, and fixing device to form and fix a non-decolorable image on the sheet,
controls the conveyance control device to convey the sheet on the conveyance path to the position upstream of the transfer unit, and
controls the decolorable image forming unit, transfer unit, and fixing device to form and fix a decolorable image on the sheet over the non-decolorable image.

24. The apparatus according to claim 23, wherein:
the control panel is further configured to receive an input selecting a document format out of a plurality of document formats each having predetermined coordinate information, wherein
when the security mode is selected:
the control panel waits to receive the input selecting the document format, and
the decolorable image is formed on the sheet in accordance with the predetermined coordinate information corresponding to the selected document format.

25. The apparatus according to claim 24, wherein the predetermined coordinate information for each of the plurality of document formats corresponds to a position of confidential information in the respective document format.

26. The apparatus according to claim 23, further comprising:
a control panel configured to receive an input selecting coordinate information with respect to an image formed on the sheet, wherein
when the security mode is selected:
the control panel waits to receive the input selecting the coordinate information, and
the decolorable image is formed on the sheet in accordance with the selected coordinate information.

27. The apparatus according to claim 23, wherein the control unit controls the non-decolorable image forming unit to form the temporary image on the transfer belt using non-decolorable toner based on image data generated by a scanner.

28. The apparatus according to claim 23, wherein the control unit controls the non-decolorable image forming unit to form the temporary image on the transfer belt using non-decolorable toner based on image data received via a network.

29. The apparatus according to claim 21, further comprising:
a scanner configured to generate an image of the sheet, wherein:
when the erasing mode is selected and before the decolorable image is decolored, the control unit:
controls the scanner to generate an image of the sheet on which the non-decolorable and decolorable images are formed,
identifies coordinate information of the decolorable image based on the generated image, and
stores the coordinate information in a storage device.

30. The apparatus according to claim 29, wherein the control unit controls the non-decolorable image forming unit, transfer unit, and fixing device to form and fix a non-decolorable code image on the sheet, the non-decolorable code image corresponding to the coordinate information.

31. A method of controlling an image forming apparatus that includes a transfer belt, a non-decolorable image forming unit that forms a temporary image on the transfer belt using non-decolorable toner, a decolorable image forming unit that forms a temporary image on the transfer belt using decolorable toner, a transfer unit that transfers each temporary image formed on the transfer belt to a sheet, and a fixing device configured to fix the temporary image formed of any one of the decolorable toner and non-decolorable toner to the sheet by heating the sheet to a fixing temperature, the method comprising:
receiving a selection of one of a security mode and an erasing mode;
when the erasing mode is selected, conveying a sheet, on which a decolorable image formed with the decolorable toner is fixed, to the fixing device; and
control the fixing device to decolor the decolorable image by heating the sheet to a decoloring temperature higher than the fixing temperature.

32. The apparatus according to claim 31, further comprising:
when the security mode is selected,
controlling the non-decolorable image forming unit, transfer unit, and fixing device to form and fix a non-decolorable image on the sheet,
conveying the sheet from a position downstream of the fixing device in a sheet conveying direction to a position upstream of the transfer unit in the sheet conveying direction; and
controlling the decolorable image forming unit, transfer unit, and fixing device to form and fix a decolorable image on the sheet over the non-decolorable image.

33. The method according to claim 32, further comprising:
when the security mode is selected, receiving an input selecting a document format out of a plurality of document formats each having predetermined coordinate information, wherein the decolorable image is formed on the sheet in accordance with the predetermined coordinate information corresponding to the selected document format.

34. The apparatus according to claim 33, wherein the predetermined coordinate information for each of the plurality of document formats corresponds to a position of confidential information in the respective document format.

35. The method according to claim 32, further comprising:
when the security mode is selected, receiving an input selecting coordinate information with respect to an image formed on the sheet, wherein the decolorable image is formed on the sheet in accordance with the selected coordinate information.

36. The method according to claim 32, wherein the non-decolorable image forming unit forms the temporary image on the transfer belt using non-decolorable toner based on image data generated by a scanner.

37. The method according to claim 32, wherein the non-decolorable image forming unit forms the temporary image on the transfer belt using non-decolorable toner based on image data received via a network.

38. The method according to claim 31, further comprising:
when the erasing mode is selected and before the decolorable image is decolored,
generating an image of the sheet;
identifying coordinate information of the decolorable image based on the generated image; and
storing the coordinate information in a storage device.

39. The method according to claim 38, further comprising:
controlling the non-decolorable image forming unit, transfer unit, and fixing device to form and fix a non-decolorable code image on the sheet, the non-decolorable code image corresponding to the coordinate information.
